(19) United States
(12) Patent Application Publication
(10) Pub. No.: US 2011/0096975 A1
(43) Pub. Date: Apr. 28, 2011

(54) SYSTEMS AND METHODS FOR IDENTIFYING MICROPARTICLES

(75) Inventors: Chengyong YANG, Foster City, CA (US); Robert BEAUDOIN, Cambridge, MA (US); Curtis GEHMAN, Burlingame, CA (US); Andrew SHERIDAN, Marblehead, MA (US)

(73) Assignee: LIFE TECHNOLOGIES CORPORATION, Carlsbad, CA (US)

(21) Appl. No.: 12/878,943

(22) Filed: Sep. 9, 2010

Related U.S. Application Data
(60) Provisional application No. 61/240,977, filed on Sep. 9, 2009.

(51) Int. Cl. G06K 9/00

(52) U.S. Cl. 382/133; 382/128

(57) ABSTRACT

Disclosed are systems and methods for identifying microparticles or features arranged in high density arrays. Using the techniques of the present teachings allow for effective discrimination and characterization of microparticles such as sequencing beads or features having densities of about 39×10⁶ particles/cm² or more. In certain embodiments, such identification can be achieved via use of two or more images corresponding to respective subsets of the microparticles or features. In certain embodiments, microparticles in each such subset can be configured with a target that hybridizes with a labeled probe, thereby resulting in the corresponding image having lower density of objects to identify.

### RELATED APPLICATION

This application claims priority pursuant to 35 U.S.C. §119(e) to U.S. Provisional Patent Application Ser. No. 61/240,977, filed on Sep. 9, 2009, entitled “Systems and Methods for Identifying Microparticles” the entirety of this application being incorporated herein by reference thereto.

### BACKGROUND

1. Field

The present disclosure generally relates to the field of image processing, and more particularly, to systems and methods for imaging densely populated particles or features associated with high-throughput DNA sequencing devices.

2. Description of the Related Art

Many biological analysis processes utilize microscopic imaging techniques. For example, florescent-based sequencing processes may utilize an array or population comprising a large number of microscopic structures or features that facilitate or serve as a substrate or support for interactions between analytes and reagents. Imaging of such features to detect, for example, fluorescent signals resultant from molecular interactions can yield useful information about the composition of the analytes. In one exemplary application such images can be used to resolve the sequences of nucleic acid samples.

In imaging applications such as used in connection with fluorescent-based sequencing analysis, the number of features or structures can influence the throughput of sequencing analysis. Generally, greater throughput and/or reduced reagent consumption can be achieved using a larger number of such microscopic features or structures. One way to achieve larger feature numbers is to increase their density within a given area. However, such increases in density can create imaging and signal resolution issues, for example, due to the close proximity of features with respect to one another.

### SUMMARY

Various embodiments of an analyte imaging system are provided herein. In one embodiments, the present teachings set forth a method for microparticle identification used in sequencing processes, comprising; for one or more of a plurality of subsets of microparticles contained within a set of microparticles distributed within an area, obtaining a subset image representative of the microparticles and based on signals resulting from detectable characteristic associated with the subset of microparticles distributed within the area; identifying the microparticles in each subset image; and combining the microparticle identifications obtained from the subset images so as to yield a combined set of microparticle identifications.

In another embodiment, the present teachings describe a method for imaging in a biological analysis process, comprising; providing a set of particles to an area, the set of particles distributed over the area and configured to facilitate a plurality of reactions between analytes associated with the particles and reagents introduced to the particles, the set of particles comprising N subsets of particles, the quantity N being greater than one, each subset having particles distributed over the area and capable of emitting signals detectably different than signals from another subset of particles during at least some of the plurality of reactions; generating an enhanced list of identified particles of the set by; obtaining N images of the area, each image corresponding to signals from each of the N subsets of particles; for each of the N images, identifying at least some of the subset of particles; and combining the identified particles of the subsets; and for a given reaction, obtaining N images corresponding to the detectably different signals from the area and identifying particles in the N images based on the enhanced list of identified particles.

In still further embodiment, the present teachings describe a biological analysis system, comprising a flow cell configured to receive a population of microparticles distributed in an area and facilitate a sequence of reactions between analytes coupled to the microparticles and reagents flowing selectively through the flow cell, each of the microparticles being in one of N sub-populations based on type of signal emitted during a selected portion of the sequence of reactions, each sub-population of microparticles distributed in the area; an assembly of optical elements configured to form an image of the area; an imaging detector configured to detect the image and generate a signal representative of the image; and a processor configured to induce imaging of each of the N sub-populations of microparticles based on the type of signal, the processor further configured to process the N images to identify microparticles therein and combine the identified microparticles from the N images to yield an enhanced list of identified microparticles.

In another embodiment, the present teachings provide a storage medium having a computer-readable instruction, the instruction comprising; obtaining data representative of N images, each of the N images corresponding to detection of microparticles having a distinguishable fluorescence characteristic; and for each of the N images: identifying microparticles in the image; aligning the image to a common image such that the N images share a substantially common frame of reference; and ranking the identified microparticles based on fluorescent intensity so as to provide preference to identified microparticles having higher intensity values.

### BRIEF DESCRIPTION OF THE DRAWINGS

FIG. 1 show a block diagram of a system that can be representative of certain embodiments of the present disclosure, where the system can be configured to detect and analyze biological related processes such as nucleic acid sequencing processes;

FIG. 2 shows that in certain situations, such nucleic acid sequencing processes can include imaging of features or particles such as sequencing beads, where some of such features or particles may not be identified properly;

FIG. 3 shows that in certain situations, such limitations in particle identification can contribute to a limit in density of particles that can be used effectively;

FIG. 4 shows that in certain embodiments, a number (N) of different features can be provided to a set of particles so that each particle can have one of the different features and thus belong to one of N subsets of particles, such that subsets of particles can be identified via their respective features;

FIG. 5 shows that in certain embodiments, a process can be implemented where particles having N distinguishably detectable configurations can be provided to a given area to facilitate detection of the subsets of particles of FIG. 4;

FIG. 6 shows that in certain embodiments, the set of particles of FIGS. 4 and 5 can include a set of sequencing beads disposed in an interaction volume such as a flow cell;

FIG. 7 shows that in certain embodiments, the example flow cell can include a deposition substrate where sequencing beads disposed thereon can be grouped into one or more panels, where each panel can define the set of sequencing beads referenced in FIG. 6;

FIG. 8 shows images of an example panel having different bead densities, where performance of bead identification based on such images is limited at about 150,000 beads per panel (approximately 750 m×750 m square, thus approximately 26.7×10⁶ beads/cm²);

FIG. 9 shows images of a focal image at approximately 160,000 beads per panel (approximately 28.4×10⁶ beads/cm²) and four images whose combination as described herein allows identification of approximately 220,000 beads per panel (approximately 39.1×10⁶ beads/cm²);

FIG. 10 shows that in certain embodiments, the plurality of different features referenced in FIG. 4 can include N (e.g., N=4) primers having different configurations and disposed relative their respective beads, such that each of the four different primers can allow hybridization thereto a corresponding unique probe (e.g., oligonucleotide probe) having a distinguishable dye label;

FIG. 11 shows an example of how four subsets of beads corresponding to the four primer configurations can be utilized to better identify beads that are disposed in a relatively dense manner;

FIG. 12 shows that in certain embodiments, a process can be implemented where a reference map of a set of beads can be constructed from identifying beads in less dense images corresponding to subsets of beads;

FIG. 13 shows that in certain embodiments, a process can be implemented where the reference map of FIG. 12 can be based on an image of the set of beads, such that the images of the subsets of beads can be utilized to update the reference map by adding newly found beads;

FIG. 14A shows that in certain embodiments, a coordinate system can be assigned to a panel having the set of beads to facilitate the reference map building process of FIG. 13;

FIG. 14B shows that in certain embodiments, the coordinate system of FIG. 14A can be based on an array of pixels associated with imaging of the panel;

FIG. 15 shows a more detailed example of the process of FIG. 13;

FIG. 16A shows an example of how the process of FIG. 15 can be configured to accommodate pixelated images when generating the initial reference map based on the focalmap image of FIG. 15;

FIG. 16B shows a visual example of the process of FIG. 16A;

FIG. 17A shows an example of how the process of FIG. 15 can be configured to accommodate pixelated images when updating the reference map based on the ligation images of FIG. 15;

FIG. 17B shows a visual example of the process of FIG. 15A;

FIG. 18 shows an example of how beads identified more than once can be handled;

FIG. 19 shows an example of enhancement in bead identification performance when the example process of FIG. 15 is implemented in situations where bead deposition densities range from about 120,000 to 220,000 beads per panel (approximately 21.3×10⁶ beads/cm² to 39.1×10⁶ beads/cm²);

FIGS. 20A and 20B show enhancements in bead matching performance in situations where bead deposition densities range from about 120,000 to 140,000 beads per panel (approximately 21.3×10⁶ beads/cm² to 24.9×10⁶ beads/cm²);

FIGS. 21A and 21B show enhancements in bead matching performance in situations where bead deposition densities range from about 160,000 to 220,000 beads per panel (approximately 28.4×10⁶ beads/cm² to 39.1×10⁶ beads/cm²);

FIG. 22 shows that in certain embodiments, bead density can be proportional to throughput in base-pair identification in nucleic acid sequencing process; and

FIG. 23 shows distributions of expected throughputs as bead densities increase.

These and other aspects, advantages, and novel features of the present teachings will become apparent upon reading the following detailed description and upon reference to the accompanying drawings. In the drawings, similar elements have similar reference numerals.

### DETAILED DESCRIPTION OF CERTAIN EMBODIMENTS

The present disclosure generally relates to systems and methods for imaging signals associated with analytical devices such as biological analysis devices. By way of a non-limiting example, such biological analysis devices can include a genetic analysis device such as a nucleic acid sequencer.

In many of such devices, excitation energy such as electromagnetic energy in the fluorescent, ultraviolet, and/or visible light spectrum may be provided or transmitted to an interrogation region or analyte detection zone where samples or probes interact with analytes. In various embodiments, the samples, probes and/or analytes can be tagged with detectable labels such as fluorescent markers, dyes or molecules which are responsive to the excitation energy and produce a detectable signal arising from an interaction between the sample, probe and/or the analyte. In the context of certain nucleic acid sequencing techniques, such labeled sample/probe/analyte interactions can take place in connection with particles which may serve as a support or carrier for discrete interactions. For example, particles may be associated with specific fragments or portions of a nucleic acid strand or sample that may be desirably analyzed for example to determine its composition or sequence. Excitation of the labels attached result in detectable signals being emitted and detected, thereby allowing characterization of the sequence of the DNA sample.

While various embodiments of the present teachings describe imaging techniques associated with detecting signal emissions arising from or induced by excitation energy of selected wavelengths it will be appreciated by one of skill in the art that these teachings may also be applied in other contexts. For example, signals arising from not only from fluorescent labels or markers may be detected and analyzed but also other types of signal generating markers may be utilized which do not require an excitation source. For example, the present teachings may be readily adapted for use with chemiluminescent markers or radioactive labels which do not necessarily require an excitation source for signal detection. Similarly, different types and/or classes of markers may be utilized in a particular analysis such as using multiple fluorophores responsive to different wavelengths of excitation energy or mixed fluorescent/chemiluminescent/radioactive markers. Accordingly, the various embodiments described herein are illustrative and it will be recognized that the invention may be adapted for use in numerous contexts and as such the disclosed embodiments are not intended to the scope of the present teachings.

In certain applications, nucleic acid strands (such as DNA or RNA) being analyzed can be attached to or associated with particles such as beads. Such beads can in turn be disposed on a substrate and signals arising from or associated with the beads imaged. In various embodiments, these imaging operations capture or record signals resultant from analytical reactions such as sequencing analysis or operations occurring for example as nucleotides are incorporated into template nucleic acid strand(s) undergoing analysis. The beads can be disposed on the substrate in a number of ways. For example, beads, particles, and sample analytes can be deposited on a surface of a substrate such as a slide or flow cell which is exposed to various reagents and conditions which permit detection of the label/marker/tag. In another example, sample-containing beads or particles can be deposited on structures such as ends of densely packed fibers to form an array or collection of discrete samples that may be simultaneously imaged.

In still other embodiments, the sample undergoing analysis may not utilize a carrier such as a bead or particle but be deposited directly on a substrate surface or formed on/within a substrate so as to generate a plurality of closely packed features from which signals arising from the tags/markers/labels are desirably detected and distinguished from one another. Imaging operations whether used to detect signals associated with collections of sample-containing beads/microparticles or to detect closely spaced arrangements/clusters/lawns of sample are desirably configured to efficiently resolve the sample signals. It will be appreciated that the present teachings may be adapted for use in sample imaging operations applicable to a variety of different contexts where signals arising from high density sample features are desirably identified and resolved from one another.

In configurations where sample nucleic acid strands or fragments reside on a substrate in one of the foregoing manners, it is desirable to be able to accurately identify the beads or features that anchor/contain/localize the sample at various positions on the substrate so as to monitor where detected interactions occur. In certain situations, however, such identification of beads or features can become difficult or challenging for a number of reasons.

For example, as density of bead or features increase or as bead or feature size decreases, identification efficiency can be adversely affected due to, for example, resolving capability of optics, decreased signal intensity, limitations of bead or feature-finding algorithms, signal crosstalk or some combination thereof. As described herein, increasing the density of sample containing beads or features and/or decreasing the size of the beads or features can be an important factor that contributes to an increase in throughput of sequencing analysis.

In various embodiments, the present disclosure can improve bead or feature finding capability. In certain embodiments, such improvement can include improved bead or feature finding capabilities as well as improved bead or feature resolution both of which may occur at higher densities so as to facilitate increases in analytical throughput.

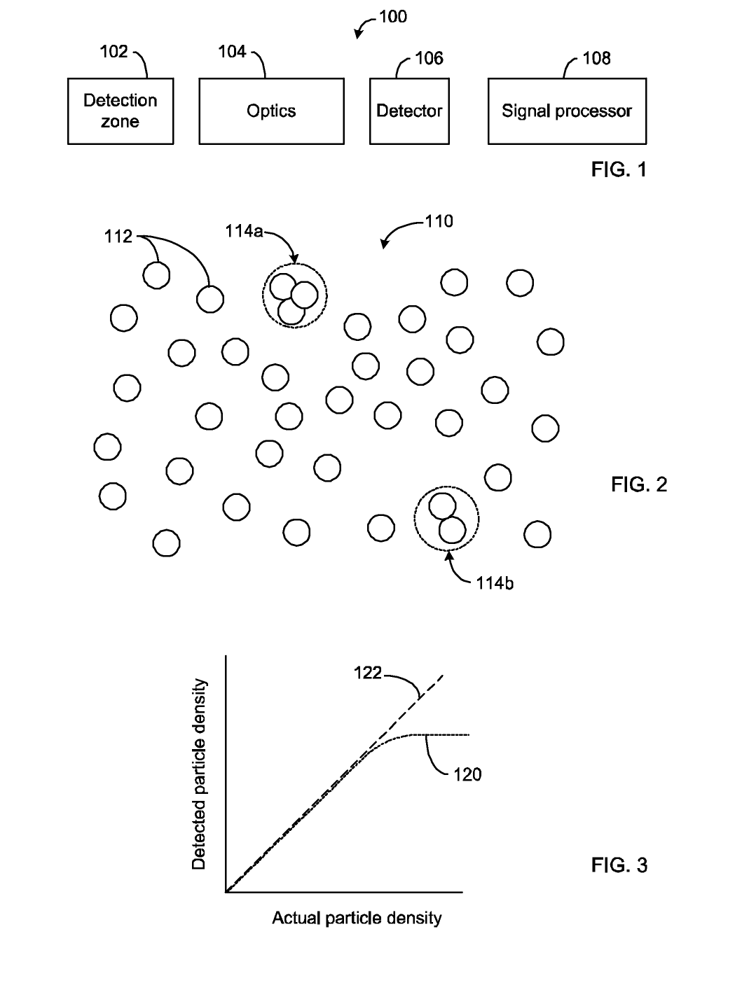

FIG. 1 shows that in certain embodiments, a biological analyzer 100 having one or more features of the present disclosure can include various components. The biological analyzer 100 can be configured to be capable of characterizing (e.g., sequence determination) biological samples (such as nucleic acid samples). In certain embodiments, the various components of the analyzer 100 can include separate components or a singular integrated system. The present disclosure may be applied to both automatic and semi-automatic sequence analysis systems as well as to methodologies wherein some of the sequence analysis operations are manually performed. Additionally, systems and methods described herein may be applied to other biological analysis platforms to improve the overall quality of the analysis.

In various embodiments, methods and systems of the present disclosure may be applied to numerous different types and classes of photo and signal detection methodologies. In certain embodiments, the detector 106 may comprise a CCD or CMOS based detector which is configured to capture signals arising from the beads or features. Signal capture may be facilitated by the optics 104 which may include various filters, lenses, and other components which direct and condition the signals associated with the beads or features such that they may be captured and/or registered by the detector 106. Additionally, although various embodiments of the present disclosure are described in the context of sequence analysis, these methods may be readily adapted to other devices/instrumentations and used for purposes other than biological analysis.

As previously described and in various embodiments, the methods and systems of the present disclosure may be applied to numerous different types and classes of excitation/signal emission methodologies and are not necessarily limited to excitation by light or laser-based excitation systems such systems may include those which do not utilize an excitation source but rather employ self-emitting tags or markers such as radioactive or chemiluminescent labels.

In the context of sequence analysis, the analyzer 100 can include a detection zone 102 where sequencing reactions occur. In certain embodiments, the detection zone 102 can include clonally amplified nucleic acid strands anchored to particles such as microbeads. Such beads can populate a detection platform such as a slide. As previously described, use of beads is not required, however, and the sample to be interrogated may be secured or retained on the substrate in various manners. Although the description provided herein discusses imaging processes in the context of beads deposited on slides, it will be understood that in other arrangements or embodiments different sample substrates or manners of sample analysis may be used including both microparticle (e.g. bead-based) approaches as well as approaches for which image features are not necessarily associated with beads but nonetheless can benefit from one or more features of the present disclosure.

As shown in FIG. 1, the analyzer 100 can include an assembly of optics 104 configured to form an image of an object located in the detection zone 102. In certain embodiments, such an object can be a portion of the slide where beads are deposited or sample features are present. As described herein, a panel defines such a portion on the slide; and a given slide can be imaging by combining the results obtained from one or more such panels.

As shown in FIG. 1, the analyzer 100 can include a detector component 106 configured to detect the image of the object in the detection zone 102. In certain embodiments, the detector component 106 can be configured to detect and measure signals arising from dye labeled probes attached to or associated with nucleic acid strands (including for example primers associated with the DNA strands). Nucleic acid strands or fragments can further be anchored to or retained by beads or microparticles or present as features secured to the substrate as reflected by the imaging of a given panel.

As shown in FIG. 1, the analyzer 100 can include a signal processor component 108 configured to process the detected signals from the detector component 106. In certain embodiments, the processor 108 can be configured to perform one or more processes as described herein based on various images obtained via the detector 106. In certain embodiments, the processor 108 can also be configured to control one or more operations (e.g., detection zone control, focus control, exposure control, detector control, signal acquisition, signal processing, analysis of data, etc.) associated with the analyzer.

In certain embodiments, the analysis of data (e.g., base calling in sequencing analysis) may be performed by the processor 108. The processor 108 may further be configured to operate in conjunction with one or more other processors. The processor's components may include, but are not limited to, software or hardware components, modules such as software modules, object-oriented software components, class components and task components, processes methods, functions, attributes, procedures, subroutines, segments of program code, drivers, firmware, microcode, circuitry, data, databases, data structures, tables, arrays, and variables. Furthermore, the processor 108 may output a processed signal or analysis results to other devices or instrumentation where further processing may take place.

Further details of exemplary systems and methods suitable for use with the present teachings include Assignee's PCT Application Publication No. WO 2006/084132, entitled “Reagents, Methods, And Libraries for Bead-Based Sequencing,” U.S. patent application Ser. No. 12/873,194 entitled “Low-Volume Sequencing Systems and Method of Use,” filed Aug. 31, 2010, and Ser. No. 12/873,132 entitled “Fast-Indexing Filter Wheel and Method of Use” filed Aug. 31, 2010, the entireties of which are incorporated herein by reference thereto.

FIG. 2 depicts a group 110 comprising a plurality of features or particles 112 exemplifying how misidentification or nonidentification of features or particles may occur. In the context of sequencing applications such as next generation nucleic acid analysis platforms using bead based signal identification, the particles can be sequencing beads to which are tethered or coupled nucleic acid fragments subjected to sequencing chemistry reactions designed to generate discernable signals representative of the constituent bases of the fragment (e.g. A, G, T, C). Such beads can have one or more DNA strands or fragments attached thereto, and may be subjected to various detection chemistries utilizing markers or tags such as fluorescent labels that distinguish the composition and sequence of the nucleic acid fragments associated with respective beads, particles, or features.

For the purpose of description, particles such as the beads 112 do not necessarily need to have generally spherical or bead-like shapes. In many situations where one or more features of the present disclosure can be applied, images of “particles” generally result from relative small point or point-like signal (e.g., fluorescence) sources. Thus, it will be understood that the present disclosure can also be applied to situations where it is desirable to be able to identify and discriminate densely packed signal sources that may behave as point or point-like objects.

When a group of particles or signal sources are disposed in a given area, some of such objects can be either clustered together or be overlapped. For example, FIG. 2 shows clusters 114a and 114b where particles are either packed relatively close (when compared to some average particle spacing) or overlapped from an imaging point of view. Overlapping may take the form of signal crossover or crosstalk where the features remain physically separate from one another however due to their close proximity the signals arising from the features appears to intermingle and be difficult to individually resolve in whole or in part. Such clusters may not readily be resolved into individual particles or features under certain circumstances. Limitations in optics and/or detector resolution, limitations in particle-finding algorithms, signal dispersion and relative signal intensities and various combinations thereof are some example factors that can contribute to such performance limitations.

Such limitations in particle-identifying capability can become more significant as the overall density of particles increases and/or the size of the particles decrease. In certain situations, and as shown in FIG. 3, such performance limitations can be manifested in detected particle density 120 reaching a saturation point (at the plateau shown) at certain value of actual particle density. In such a situation, providing particle densities beyond the saturation point may not be beneficial and adversely affect both the quality and performance of the analysis. In fact, there may be situations where the density of particles or features extend beyond the identification and resolution capability of a conventional system which can undesirably impact the overall analysis. As an example, a cluster that might be otherwise identified as a singular particle may in fact contain multiple particles emitting different signals creating ambiguities that can yield erroneous results during analysis.

As described herein, one or more features of the present disclosure can facilitate and extend the detectable particle density limit of conventional imaging systems. Such beneficial capabilities can be manifested as a detected particle density curve 122 that extends beyond the plateau of the curve 120 and provide improved data quality, throughput, and efficiency compared to conventional systems.

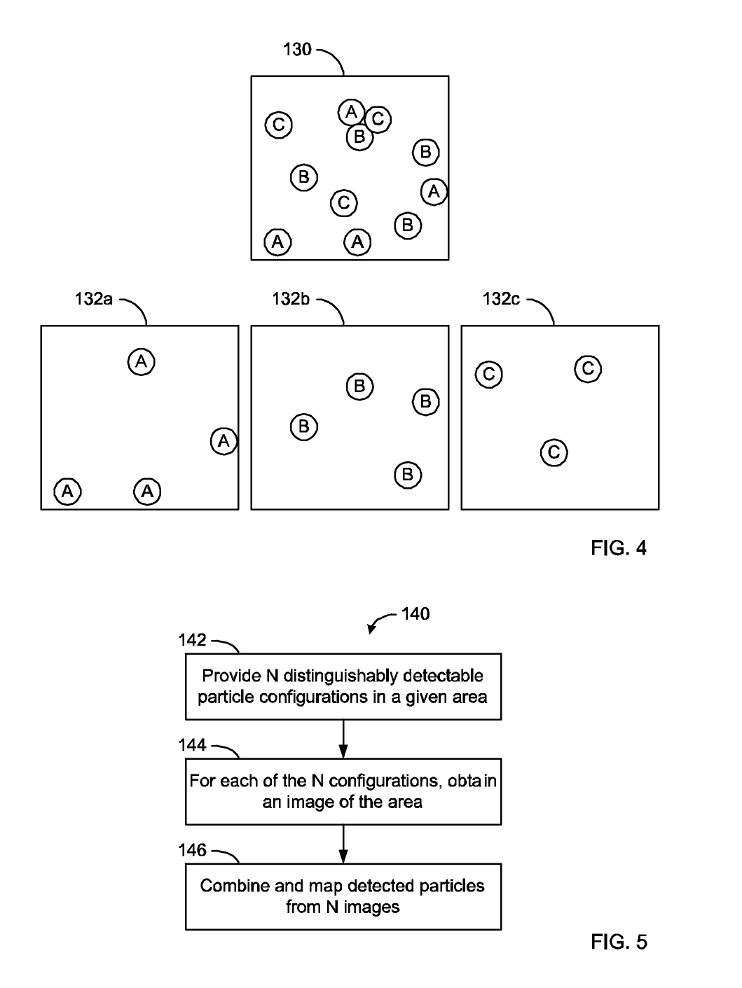

FIG. 4 shows that in certain embodiments, a plurality of different detectable configurations can be provided to a set of particles so that each particle can be associated with one of the different configurations. As described herein in greater detail, such different configurations can include different-sequenced primers or labels that are associated with respective beads, such that a given bead has one or more nucleic acid strands attached to the bead via a unique primer or generates as unique signal resultant from the associated label. A unique labeled probe can hybridize to the corresponding unique primer, thereby allowing detection of the nucleic acid fragment or template associated with a selected bead via detection of the unique labeled probe. In the context of bead-based sequencing examples described herein, there can be for example four such unique markers or labels corresponding to different constituent nucleotide bases. Alternatively, as is the case with SOLiD sequencing approaches employed by Life Technologies the markers or labels may be associated with primer/probe combinations which reflect encodings of two or more bases where the emitted signal may represent one or more particular encodings which is subsequently resolved to yield the underlying sequence associated with the nucleic acid template or sample. From the aforementioned examples, it will be understood that for the purpose of increasing the particle-finding capability, there can be other numbers and types of such different configurations.

In FIG. 4, an example set 130 is depicted as having particles, with each particle having one of example three configurations. These configurations may be representative of distinguishable or different fluorophores or markers associated with subsets of the particles. The composition and distribution of the markers may be dependent on the stage of the analysis and particles may be associated with different markers over the course of the analysis (e.g. during sequential or different base sequencing rounds.) For example, particles denoted as “A” may include a designated marker and be distributed in a unique configuration, and so on. Such distinguishably detectable configurations allow imaging of subsets 132a, 132b, and 132c where only the corresponding particles are imaged. As shown, each of the three example subset images 132 show particles that are less dense than that of the set 130. As such, identification of specific particles (e.g., A, B, or C) can be performed as if the particle density is at a level of the subset image. As discussed above, particle or feature subsets may arise from the use of different markers, tags, or labels used during sample analysis and may further change from one round or stage of the analysis to the next depending on the sample composition and the marker affinity or reactivity for the sample.

As one can appreciate, such capability can be beneficial, since a particle-finding algorithm can be utilized at a particle-density value that is a fraction of the full set 130. In the example shown in FIG. 4, if approximately same number of the A, B, and C particles are deposited on a substrate, particle density of each of the subsets can be approximately ⅓ of the density of the full set.

FIG. 5 shows a process 140 that can be implemented to find particles based on the example shown in FIG. 4. In a process block 142, particles in a given imaged area can be provided with N distinguishably detectable configurations. In a process block 144, an image of the area can be obtained for each of the N distinguishably detectable configurations. In a process block 146, N images of the distinguishably detectable configurations can be combined to map particles detected under lower imaging density situations.

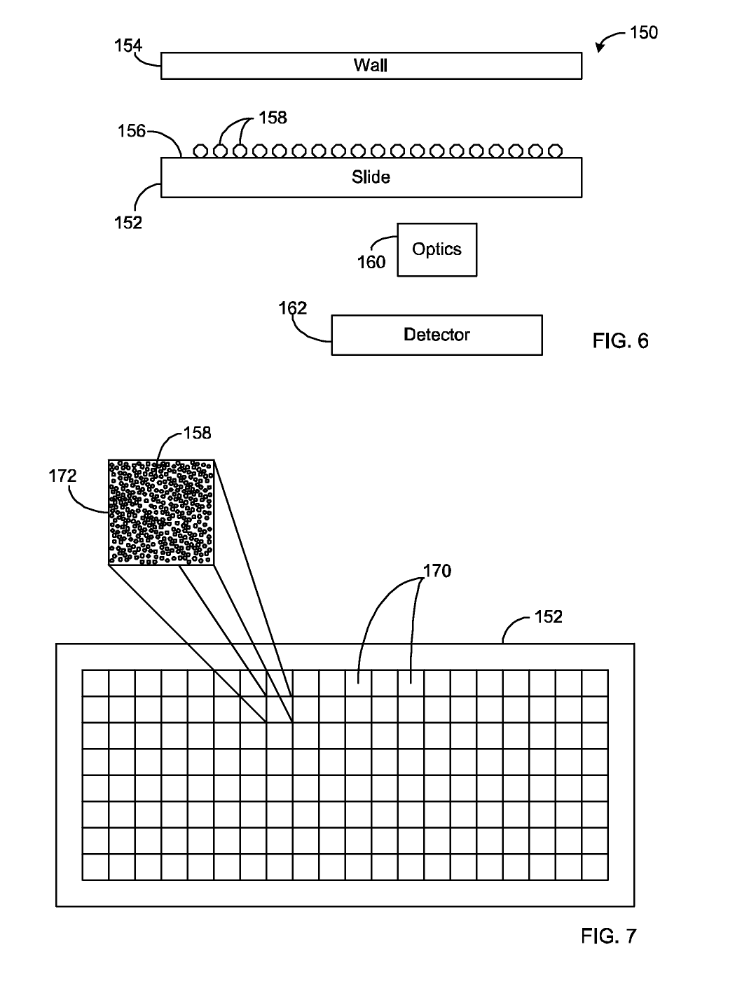

FIGS. 6 and 7 show a non-limiting example detection situation where one or more features of the present disclosure can be implemented. In FIG. 6, a simplified view of a flow cell 150 is shown as having a plurality of beads 158 deposited on a surface 156 of a slide 152. A volume defined by the slide 152 and a wall 154 can be provided with various probe particles and associated chemistries to facilitate detection of interactions for sequencing DNA samples (not shown) attached to the beads 158. Next generation sequencing techniques commonly utilize flowcell technologies for sample analysis. For example, Assignee's PCT Application Publication No. WO 2006/084132, entitled “Reagents, Methods, And Libraries for Bead-Based Sequencing,” provides various techniques, systems, and methods for sequencing a sample coupled to a solid-support (e.g., a bead) wherein a plurality of supports are disposed over the surface of a flowcell. Flowcells allow for a large number of samples, or samples coupled to solid-supports, to be immobilized in random and/or ordered fashion across reaction chamber(s) while reagents are pumped through the chamber(s) to produce the desired effect (e.g., reaction, wash, etc.). Typical systems also include imaging/optics components in communication with the reaction chambers thereby allowing sample images to be rapidly captured and analyzed.

Images of beads 158 facilitating such interactions can be obtained via an optics assembly 160 and a detector 162. SOLiD System available from Life Technologies/Applied Biosystems is a non-limiting example of a high-throughput sequencing device that utilizes a flow cell similar to that described in reference to FIG. 6.

FIG. 7 shows that in certain embodiments, beads 158 deposited on the slide 152 can be grouped into one or more panels 170. An enlarged view 172 of one of the panels 170 shows the beads deposited thereon. For the purpose of description, a panel can be an area where a set of beads are imaged together.

In the example panel 172, the beads 158 are shown to be deposited in a substantially random manner. It will be understood, however, that one or more features of the present disclosure can be applied to semi-ordered or ordered arrays of beads or other particles.

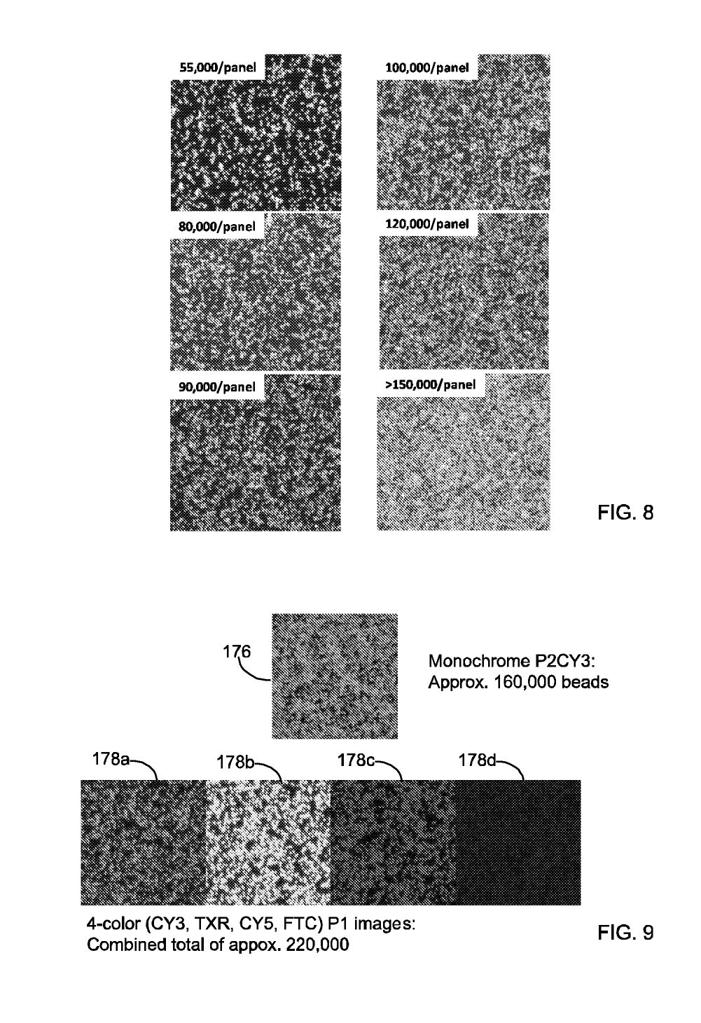

FIG. 8 shows exemplary images of beads disposed on panels. The example images show portions of E. coli template beads deposited at varying bead densities as indicated. For the purpose of description herein, a panel may be a generally square region having an approximately 750 m side. Thus, a value D1 expressed in beads/panel can be converted to a value D2 expressed beads/cm² by dividing the quantity D1 by a quantity 0.005625. Thus, 100,000 beads/panel is equivalent to 17.8×10⁶ beads/cm², and so on. It will be appreciated that the panel dimensionality/configurations, sample templates, particle densities, and other features illustrated in FIG. 8 are exemplary in nature and other configurations are contemplated to be within the scope of the present teachings. For example, different sample templates may be used during the sequencing analysis as well as different panel acquisition strategies based on particles size & density, marker type, per panel area, and the like.

Images such as those shown in FIG. 8 can be used to illustrate a range of bead densities for which an analysis algorithm can efficiently identify/discriminate individual beads. With use of such templated bead images, an example bead finding algorithm can identify about 150,000 beads per panel (about 27×10⁶ beads/cm²).

FIG. 9 shows an image 176 of beads obtained using a particular label (for example using the fluorescent dye CY3) attached to primer specific probes (described below in greater detail). With use of such labeled probes, the example bead finding algorithm identifies about 160,000 beads per panel (about 28×10⁶ beads/cm²) and generally comparable to that shown in FIG. 8.

As described herein, two or more different imagings of the exemplary area of reflected by the panel can be obtained, where each image includes distinguishably detectable signals from a subset of the beads in the panel. Thus, for each image, a lessor number of beads may be identified using for example different markers/labels than that of a monochromatic image (where all of the signal emitting beads emit the same type of signal for example resultant from the same marker/label). As described herein, such two or more different images can be used to facilitate identification of higher densities of beads.

For example, four sample images (178a-178d) shown in FIG. 9 correspond to different fluorescent labels (e.g. different associated dyes CY3, TXR, CY5, and FTC) attached to or associated with primer specific probes (described below in greater detail). When such images are used as described herein, a combined total of approximately 220,000 beads/panel (about 39×10⁶ beads/cm²) or higher density of beads can be effectively identified.

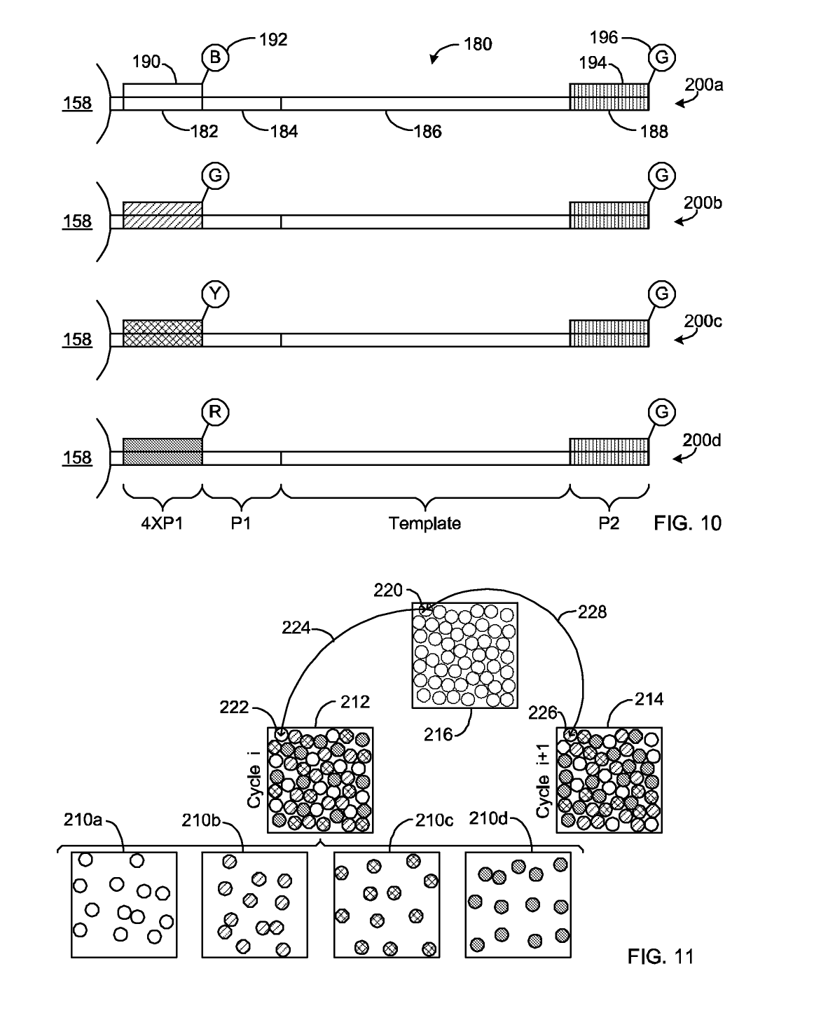

In certain embodiments, one or more features of the present disclosure can be implemented in ligation-based high-throughput DNA sequencing applications such as that associated with Applied Biosystem's SOLiD System. FIG. 10 shows four different bead arrangements (200a-200d) associated with corresponding four different primers (182) and probes (190). For the example configuration 200a, a DNA strand 180 is shown to be attached to a bead 158a via a primer 182 (unfilled pattern), and a probe 190 (unfilled pattern) having a label 192 (exemplary blue light emitting) is shown to be hybridized to the corresponding primer 182. For the example configuration 200b, a DNA strand 180 is shown to be attached to a bead 158b via a primer 182 (slanted line pattern), and a probe 190 (slanted line pattern) having a label 192 (exemplary green light emitting) is shown to be hybridized to the corresponding primer 182. For the example configuration 200c, a DNA strand 180 is shown to be attached to a bead 158c via a primer 182 (cross hatch pattern), and a probe 190 (cross hatch pattern) having a label 192 (exemplary yellow light emitting) is shown to be hybridized to the corresponding primer 182. For the example configuration 200d, a DNA strand 180 is shown to be attached to a bead 158d via a primer 182 (shaded pattern), and a probe 190 (shaded pattern) having a label 192 (exemplary red light emitting) is shown to be hybridized to the corresponding primer 182.

In certain embodiments, the 5′ end of the template portion of the strand 180 can be attached to the four unique primers 182 (denoted as 4×P1) via a universal primer (denoted as P1). As shown also, the 3′ end of the template can be attached to a universal P2 primer 188 (vertical line pattern). Thus, a common probe 194 (vertical line pattern) having a common label 196 (in this example, a green light emitting label) can be hybridized to each of the four P2 primers 188. As described herein, such common probes can be utilized to obtain a monochromatic focalmap image of the beads in a given panel. In certain embodiments as described herein, such a focalmap image can provide a basis for constructing a reference map using four unique-probe based images.

FIG. 11 depicts images 210 representative of the four distinguishably detectable bead configurations of FIG. 10. For the purpose of description, such images can also be referred to as P1 images. More particularly, P1 image 210a corresponds to beads having the configuration 200a; 210b corresponds to beads having the configuration 200b; 210c corresponds to beads having the configuration 200c; and 210d corresponds to beads having the configuration 200d. In certain embodiments, a combined image 212 can include more identified beads than that of a monochromatic P2 image (not shown) due to higher efficiency in bead identification in each of the less dense P1 images.

As described herein, a reference map 216 can be based on the combination of the P1 images 210. Because such a reference map is based on the less dense P1 images 210, there is likely a greater number of beads represented in the map 216 than a reference map based on the P2 image alone.

As shown in FIG. 11, the reference map 216 can be used to identify beads in different images obtained during a sequencing process. For example, suppose that the example image 212 is representative of ligation cycle “i,” and an example image 214 is representative of ligation cycle “i+1.” Then, a bead entry 220 in the reference map 216 can identify bead 222 in image 212 as being the same as bead 226 in image 214.

As described herein, use of different colored images (e.g. using multiple tags/markers/labels for selected subpopulations of beads) obtained during ligation cycles allows finding of beads in a less crowded (and hence less crosstalk) environment. In principle, a set of different colored ligation images or differentially labeled sub-populations of nucleic acid templates, beads, or features can be combined to generate and/or update a reference map. In certain embodiments, colored images or similarly labeled templates, beads, or features from the same ligation cycle may be desirable due to the commonality in operating and imaging conditions. In certain embodiments, earlier ligation cycles can be preferable and give rise to less crosstalk among the beads. Thus in certain embodiments, images obtained from the earliest ligation cycle can be used for generating and/or updating a reference map. In the context of the example configuration shown in FIG. 10, such earliest cycle can be the Primer Cycle 1 and Ligation Cycle 1 (P1C1). Many of example data and results described herein correspond to such ligation images. While the above-described examples discussion imaging processes in the context of a ligation based sequence analysis approach, it will be understood that the particle identification and resolution methods described herein may be readily applied in other contexts. For example, high density feature identification and discrimination may be desirably for use in connection with hybridization based microarrays such as those commercially available from Affymetrix Inc. Additionally, the approaches described in the present teachings may be readily adapted to other sequencing platforms such as those employing bead-based as well as non-bead-based approaches. For example, sequencing platforms such as those used by Illumina Inc., 454 Technologies Inc., and Complete Genomics Inc. give rise to many closely spaced discrete features emitting signals which are desirably optically resolved and distinguished from one another during a series of reaction steps. In such systems it may be desirable to identify areas associated with one or more features, beads, microparticles, or the like and to employ methods as taught by the present teachings to facilitate subset feature identification so as to improve overall feature identification. Similarly, the system, methods, and software analysis approaches described herein are not limited to use with a particular type of biological analysis approach or technology and may be used in a variety of different applications where high density feature identification is desirable.

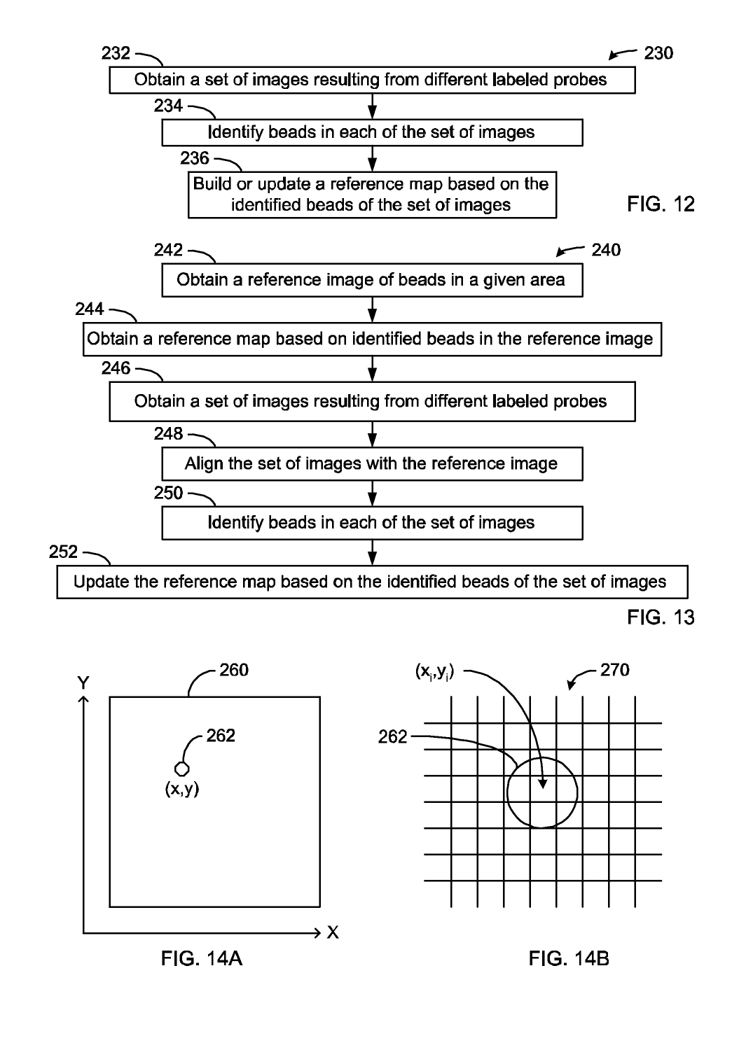

FIG. 12 shows a process 230 that can be implemented to generate a reference map depicted in FIG. 11. In a process 232, a set of images resulting from different labeled probes can be obtained. In the example described in reference to FIGS. 10-11, these images can be the four P1 images (210) resulting from detection of the four unique P1 probes 182. In a process block 234, beads in each of the set of images are identified. In certain embodiments, such bead finding can be achieved using the same algorithm that is used for finding beads in monochromatic focalmap images. In a process block 236, a reference map can be built or updated based on the identified beads of the set of images.

FIG. 13 shows a process 240 that can be a more specific example of the process 230 of FIG. 12. In the process 240, a reference map can be initially based on an image other than P1 images. Thus, in a process block 242, a common image of beads in a panel can be obtained. In certain embodiments, such common image can be a monochromatic focalmap image resulting from common probes hybridized to the common P2 primer. In a process block 244, a reference map can be generated based on the common image. An example of such map generation is described herein in greater detail. In a process block 246, a set of images resulting from different labeled probes can be obtained. In a process block 248, the set of images can be aligned with the common image so as to provide computed and common positioning of beads from different images. In a process block 250, beads in each of the set of images can be identified. In certain embodiments, such bead finding can be achieved using the same algorithm that is used for finding beads in the common image. In a process block 252, the existing reference map (based on the common image) can be updated using the identified beads of the set of colored P1 images.

In certain embodiments as described in reference to FIG. 13, various panel images can be aligned to provide computed and common position indexing of beads from different images. FIG. 14A shows that in certain embodiments, a position coordinate system can be assigned to each panel, and alignment or other comparison of panels can be facilitated by such coordinate systems. For example, an example panel 260 is shown to be assigned with an XY coordinate system, such that a given bead 262 has (x,y) coordinates.

In certain embodiments, the panel coordinate system can be based on segmented nature of images formed on segmented detectors. FIG. 14B shows an image of an example bead 262 formed on a segmented detector 270. As shown, the bead image 262 covers pixels surrounding a pixel indicated as (xᵢ,yᵢ). Thus, the bead location (x,y) of FIG. 14A can be represented as integer pixel coordinate (xᵢ,yᵢ) to account for pixelated nature of the image.

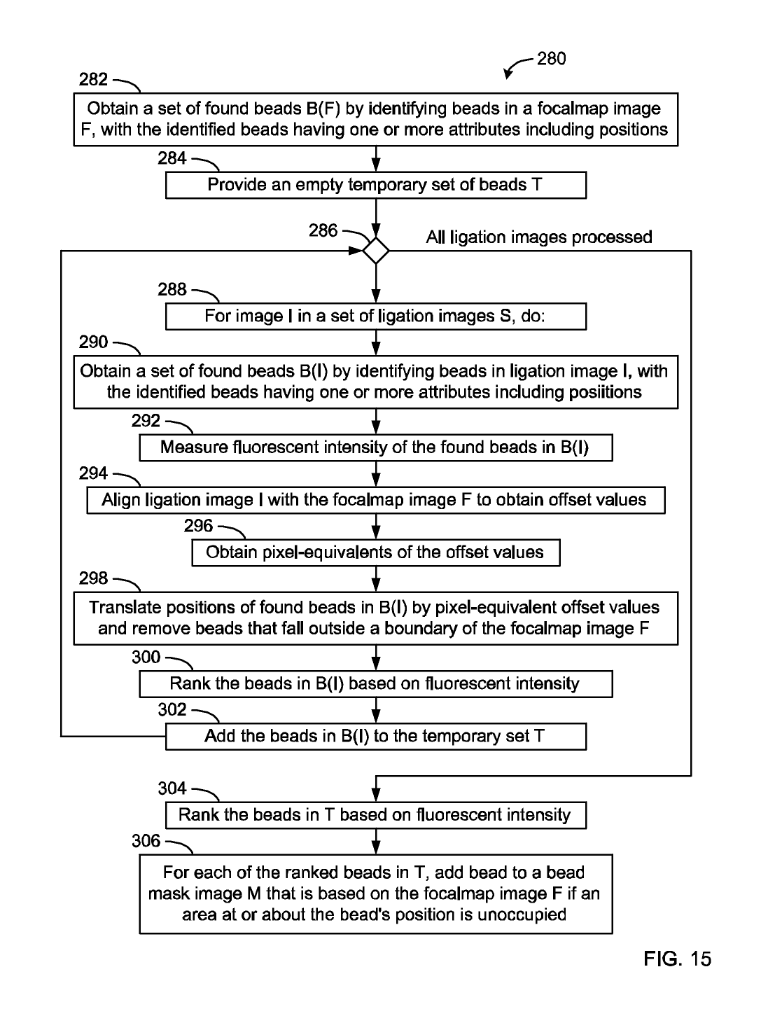

FIG. 15 shows a process 280 that can be implemented as a more specific example of the process 240 of FIG. 13. In a process block 282, a set of found beads B(F) can be obtained by identifying beads in a focalmap image F (common image in FIG. 13). Such identified beads can have one or more attributes, including positions. In certain embodiments, such attributes can also include beads' fluorescent intensities and intensity rankings. In a process block 284, an empty temporary set of beads T can be generated. As described herein, the set T can be filled with beads identified in ligation images.

In certain embodiments, process blocks 288 to 302 can be performed for each of a plurality of ligation images (e.g., four P1 images) (loop 286). Once all ligation images are processed, the process 280 can proceed to updating of the temporary set T.

For each image I of a set ligation images S (process block 288), a set of found beads B(I) can be obtained by identifying beads in the image I in a process block 290. Such identified beads can have one or more attributes, including positions. In a process block 292, fluorescent intensity of the found beads in the set B(I) can be obtained. In a process block 294, the image I can be aligned with the focalmap image F. In certain embodiments, such alignment can be achieved using a known technique where a quantity representative of overlapping of beads in the two images is maximized. Based on such alignment, offset values between the two images I and F can be obtained. In a process block 296, pixel-equivalent integer values of the offset values can be obtained. In a process block 298, positions of the found beads in the set B(I) can be translated by the pixel-equivalent offset values. In certain situations, such translation of the bead positions may result in one or more beads that fall outside of a boundary defining the focalmap image F. In certain embodiments, such beads can be discarded in process block 298. In a process block 300, the remaining translated beads in the set B(I) can be ranked based on fluorescent intensity. In a process block 302, the intensity-ranked beads can be added to the temporary set T.

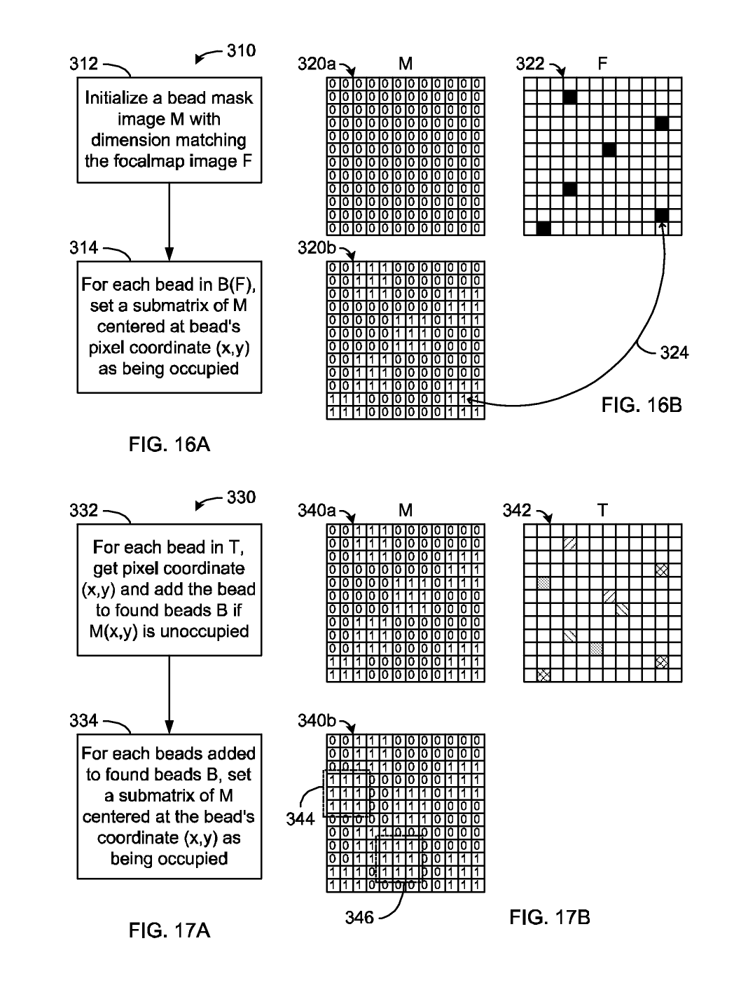

Upon processing of all the ligation images, the process 280 can rank the beads in the set T (that now includes intensity-ranked beads from all of the ligation images) based on fluorescent intensity in a process block 304. In a process block 306, ranked beads in the set T can be added to a bead mask image M if an area at or about the bead's position is unoccupied in the mask image M. In certain embodiments, the mask image M can be based on the focalmap image F. Examples of generating and populating the mask image M (also referred to as reference map herein) are described in greater detail in reference to FIGS. 16 and 17.

In certain embodiments, a manner in which the mask image M is populated can depend on factors such as bead density, bead dimension, and/or pixel dimension. In various example data and results described herein, pixels on the imaging detector are approximately ⅓ m-side squares, and beads have an average diameter of approximately 0.9 m. Thus, a given bead's diameter spans approximately 2.7 pixels. It will be understood that the examples of generating and populating the mask image M in FIGS. 16 and 17 are based on such a configuration. It will also be understood that variations to the mask image M generation and population can be implemented.

FIG. 16A shows a process 310 that can be implemented to generate a mask image M, and FIG. 16B shows an example of the mask image 320 that can accommodate the aforementioned particular example configuration. In a process block 312, a bead mask image M can be initialized as an array 320a having dimensions similar to that of the focalmap image F (322). For the purpose of description, the focalmap image F (322) and the mask map image M (320) are both depicted as 12×12 matrices. It will be understood that such depiction is for the purpose of description, and that such images can be represented as N1×N2 matrices or equivalents.

In certain embodiments, and as shown in FIG. 16B, the mask image array M (320a) can be initialized with all zeros in the process block 312 (FIG. 16A). In a process block 314, the mask image array M can be populated based on the focalmap image F. In the example arrays M and F in FIG. 16B, the darkened elements in the array F (322) are pixels representative of centers or approximate centers of beads found in the focalmap image F. For each of such beads B(F), an element corresponding to the bead's pixel can be designated as being occupied. For example, a double-ended arrow 324 depicts mapping of a bead pixel in F to a corresponding element (set to “1” from “0”) in M.

As shown in FIG. 16B, a submatrix of M (320b) centered at the bead's representative pixel can also be designated as being occupied. In the example shown, elements of a 3×3 submatrix (with the center element corresponding to the bead's pixel) are designated as also being occupied (set to 1). As described herein, the choice of 3×3 submatrix is an example selected to facilitate the example configuration. Other dimensioned submatrices may be utilized. Furthermore, a representative submatrix need not necessarily be limited on a whole pixel basis. For example, a designated area corresponding to a sub-pixel region or fractional multi-pixel region may likewise be utilized. Alternatively, the designated submatrix may be reflected by a designated area independent of pixel size, number, or dimensions. As such, these alternative approaches are understood to be other embodiments of the present teachings.

FIG. 17A shows a process 330 that can be implemented to update the mask image M, and FIG. 17B shows an example of the mask image M being updated based on the temporary set T described herein in reference to FIG. 15. Again, for the purpose of description, the mask image M (340) and the temporary set T (342) are both depicted as 12×12 matrices. It will be understood that such depiction is for the purpose of description, and that such images and/or sets can be represented as N1×N2 matrices or equivalents.

In a process block 332, pixel coordinate for each of the beads in the set T is obtained. In the example temporary set T (342), beads corresponding to the four labels B, G, Y, and R (192 (unfilled pattern, slanted line pattern, cross hatch pattern, shaded pattern) in FIG. 10) are represented by pixels having respective patterns (backward slanted line pattern to represent unfilled pattern, slanted line pattern, cross hatch pattern, shaded pattern).

At this stage, the mask image M 340a contains a map of found beads B from the focalmap image F. In the process block 332, beads from the set T can be added to the found beads B if the image mask M is unoccupied at the pixel coordinate of the beads from T. In the example shown in FIG. 17B, the beads (pixel coordinates (row, column) (2,4), (4,11), (6,7), (9,4), (11,11), (12,2)) in T have corresponding pixels already occupied in M, likely due to the beads being the same beads as already found in the focalmap image F. The beads at coordinates (5,2), (7,8), (10,6), however, are not found in the focalmap image F; and therefore can be added to the list of found beads B if the corresponding elements are unoccupied in the mask image M.

In the example shown in FIG. 17B, the element (5,2) in the mask image M is unoccupied and corresponds to the newly found bead coordinate (5,2) in the temporary set T. Thus, the bead corresponding to (5,2) in T is added to the found bead list B, and the image mask M is updated. The element (7,8) of M is occupied; thus, the bead corresponding to (7,8) in T is not added to B, and M is not updated. The element (10,6) of M is unoccupied; thus, the bead corresponding to (10,6) in T is added to B, and M is updated.

As with the process block 314 of FIG. 16A, a submatrix of M centered at the newly added bead's representative pixel can also be designated as being occupied. In the example shown in FIG. 17B, elements of a 3×3 submatrix 344 (with the center element corresponding to the newly found bead with pixel at (5,2)) are designated as also being occupied (set to 1). For the newly found bead with pixel at (10,6), some elements (in FIG. 17B, elements (9,5) and (10,5)) of its corresponding 3×3 submatrix 346 are already occupied from a previously found bead. In certain embodiments, such previously occupied elements can remain occupied so as to yield some overlapping of submatrices. In certain embodiments, completion of the process block 334 can yield an updated list of found beads B and an updated mask image M that corresponds to the list B. Such list B and/or mask image M can be used as the reference map (216) described herein in reference to FIG. 11.

In many nucleic acid analyzers, beads can be coated with or features can contain a number of same or substantially same sample or fragment nucleic acid strands. Within a certain range of densities of such sample or strands per bead/feature, more strands associated with a given bead or feature may generally yield a better (e.g. stronger/more distinct) detectable signal. Thus, it may be generally preferable to use such strong-signal generating beads than beads that yield lower intensity or quality signals.

As described herein in reference to the process 280 of FIG. 15, ranking of found beads (e.g., process blocks 300 and 304) can facilitate retaining of higher-quality beads during processes such as updating of the mask image M (FIGS. 17A and 17B). In the example process 330 of FIG. 15A, a newly found bead is added to the mask image M if the corresponding position is unoccupied. This algorithm generally places higher-intensity-ranked beads onto the mask image M first when M is less populated, thereby ensuring that such higher-quality beads will have a greater likelihood of being retained.

In certain embodiments, it may be desirable to quantify the extent of duplicate matches of beads. For example, placement or rejection of newly found beads in the process block 332 (FIG. 15A) can be at least in part due to a given bead having been identified two or more times in different images. Such duplicate or multiple identifications can be a result of one or more performance related reasons. Thus, quantifying such duplicate or multiple identifications can be useful for performance analysis and/or correction.

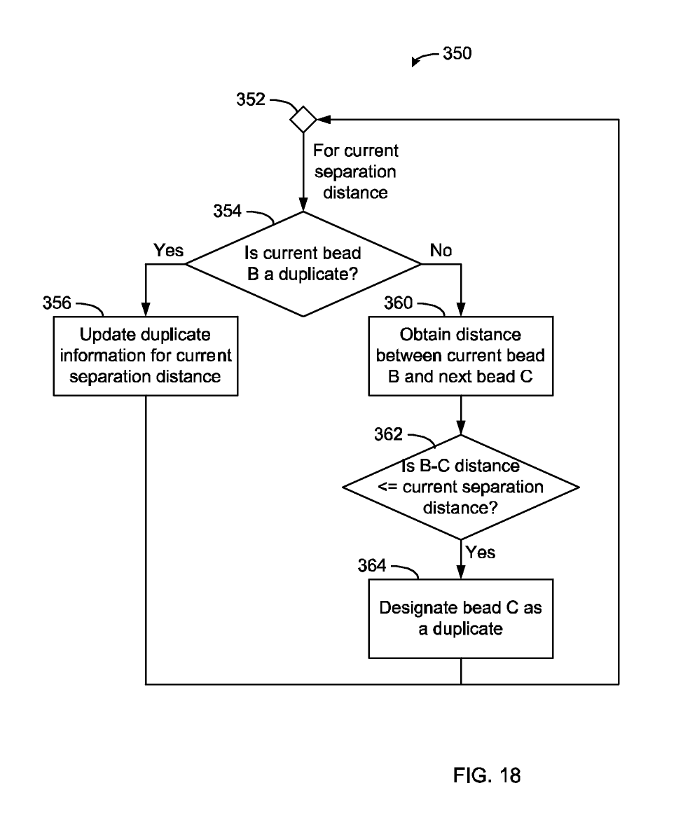

FIG. 18 shows an example process 350 that can be implemented to quantify one or more parameters associated with duplicate identification of beads. In certain embodiments, the process 350 can loop through a given set of beads, and for a given bead in the set, the process 350 can consider one or more distances between the given bead and other beads.

Thus, a loop 352 loops through one or more of such bead separation distances. In certain embodiments, such distances are selected to exclude larger separations where duplicate identification is unlikely. For a given distance, the process 350 can determine in a decision block whether the current bead B is a duplicate. If the answer is “Yes,” information about the current duplicate bead can be updated in a process block 356. For example, a duplicate count for the current distance can be incremented. If the answer is “No,” distance between the current bead B and the next bead C can be obtained in a process block 360.

In a decision block 362, the process 350 can determine whether the B-C separation distance is less than or equal to the current distance. If the answer is “Yes,” the next bead C can be designated as a duplicate to bead B in a process block 364. The process 350 can then loop through other distances.

Once completed, one or more parameters associated with duplicate bead finding phenomenon can be analyzed. For example, a distribution of separation distances (obtained via the process block 356) can yield information about, for example, image alignment performance.

As described herein, relying on a single image (such as a focalmap image) for identifying beads can lead to a limitation in bead density, beyond which identification of additional beads becomes difficult or impossible for a given bead-finding algorithm. An example of such saturation of bead identification performance can be seen in Table 1, where bead identification is performed by a given bead-finding algorithm using a monochromatic focalmap image.

TABLE 1

| Deposited Bead Density | Identified Bead Density |
|---|---|
| 220K beads/panel | 140K-150K beads/panel |
| 190K beads/panel | 140K-160K beads/panel |
| 160K beads/panel | 130K-150K beads/panel |
| 130K beads/panel | 110K-140K beads/panel |

As described herein, a panel is a square having an approximately 750 m side. Thus, a value D1 expressed in beads/panel can be converted to a value D2 expressed beads/cm² by dividing the quantity D1 by a quantity 0.005625. Thus, 130,000 beads/panel=23.1×10⁶ beads/cm², and so on.

For the example bead-finding performance listed in Table 1, the maximum density of identifiable beads (for the given bead-finding algorithm) appears to be somewhere between 140,000 and 160,000 beads/panel. As described herein, bead-finding performance can be enhanced—even with the same (or substantially same) bead-finding algorithm—by implementing one or more features of the present disclosure.

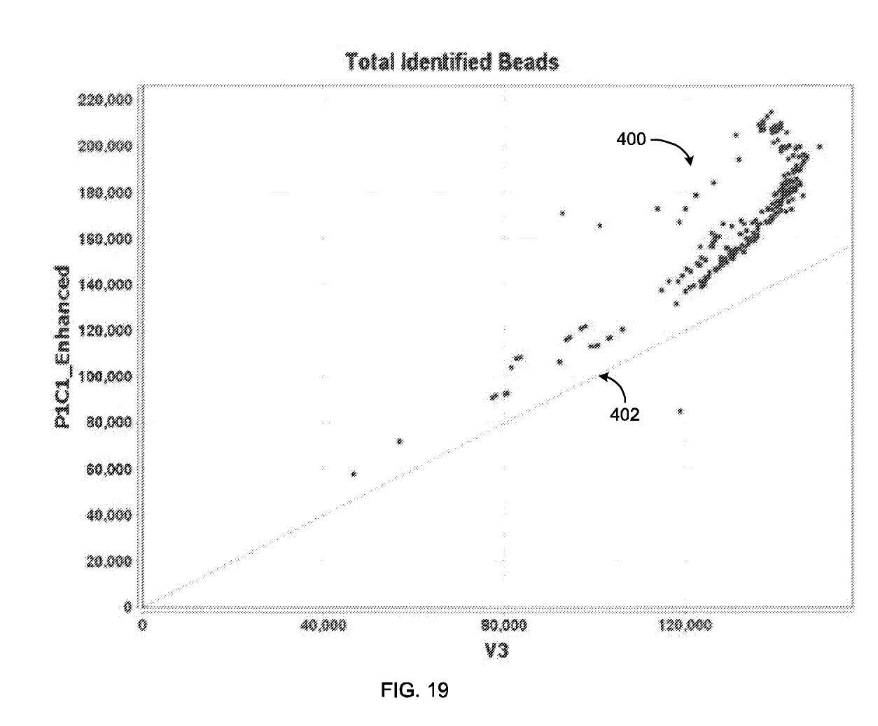

In a set of runs using a SOLiD Version 3 System, following data was obtained: 50 bp DH10b mate-pair on duplicate quad slides with bead densities of approximately 120K, 140K, 160K, and 180K beads per panel; and 50 bp single tag on duplicate quad slides with bead densities of approximately 130K, 160K, 190K, and 220K beads per panel. Based on such data, FIGS. 19-21 show examples of improvements in bead finding and matching performance by implementation of various features as described herein.

For the purpose of description herein, total identified beads refers to total number of beads that can be identified and used in every ligation cycle (see, for example, FIG. 11). Thus, the quantity for total identified beads excludes beads that are outside of the reference image (e.g., process block 248 in FIG. 13 and process block 298 in FIG. 15).

For the purpose of description herein, total matched beads refers to total number of beads having 0 to 6 mismatches when assessing bead performance using a reference genome having known and fixed number of base pairs. The matched beads are part of the identified beads.

For the purpose of description herein, perfectly matched beads refer to matched beads having zero mismatch. Thus, perfectly matched beads are part of the matched beads.

FIG. 19 shows a scatter plot 400 of total identified beads as found by a given bead-finding algorithm (used in the SOLiD Version 3 System) using a monochromatic focalmap image alone (horizontal axis, labeled as “V3”) and by the same algorithm using four color P1 images (vertical axis, labeled as “P1C1_Enhanced”). The scatter plot 400 is representative of the aforementioned data for bead densities ranging from 120K to 220K per panel. A visual reference line 402 corresponds to a one-to-one comparison (slope=1) between the horizontal and vertical scales. As shown, data points generally lie above the reference line 402, indicating that bead finding performance is enhanced overall by use of the four color P1 images (e.g. multiple fluorophores to delineate bead sub-populations).

As shown in FIG. 19, bead-finding performance saturates for V3 at bead density of about 130K (manifested by vertical and left-ward turn of the scatter pattern at about 130K to 160K). In fact, as bead density increases from 160K to 220K (on the vertical scale), ambiguity in V3 results. Thus, V3 can identify up to about 130K beads per panel in the example data.

However, the total identified beads for P1C1_Enhanced case continues to increase beyond V3's upper limitation of about 130K beads per panel. Such an increase continues to the upper limit of density (about 220K per panel) evaluated in the example data.

FIG. 20A shows a scatter plot 410 of total matched beads among beads identified via use of monochromatic focalmap image alone (horizontal axis, labeled as “V3”) and via use of four color P1 images (vertical axis, labeled as “P1C1_Enhanced”). A unity-slope line 412 is also shown for visual reference. As described herein, matched beads are identified beads having 0 to 6 mismatches when assessing bead performance using a reference genome having known and fixed number of base pairs.

For the scatter plot 410 shown in FIG. 20A, bead densities range from about 120K to 140K per panel, and the reference genome has a length of 50 bp. As shown, data points generally lie above the reference line 412, indicating that bead matching performance is enhanced overall by use of the four color P1 images.

FIG. 20B shows a scatter plot 420 of total perfect beads among beads matched via use of monochromatic focalmap image alone (horizontal axis, labeled as “V3”) and via use of four color P1 images (vertical axis, labeled as “P1C1_Enhanced”). A unity-slope line 422 is also shown for visual reference. As described herein, perfectly matched beads are matched beads having zero mismatches.

For the scatter plot 420 shown in FIG. 20B, perfectly matched beads are part of the matched beads of FIG. 20A. As shown, data points generally lie above the reference line 422, indicating that matching performance (with zero mismatches) is enhanced overall by use of the four color P1 images.

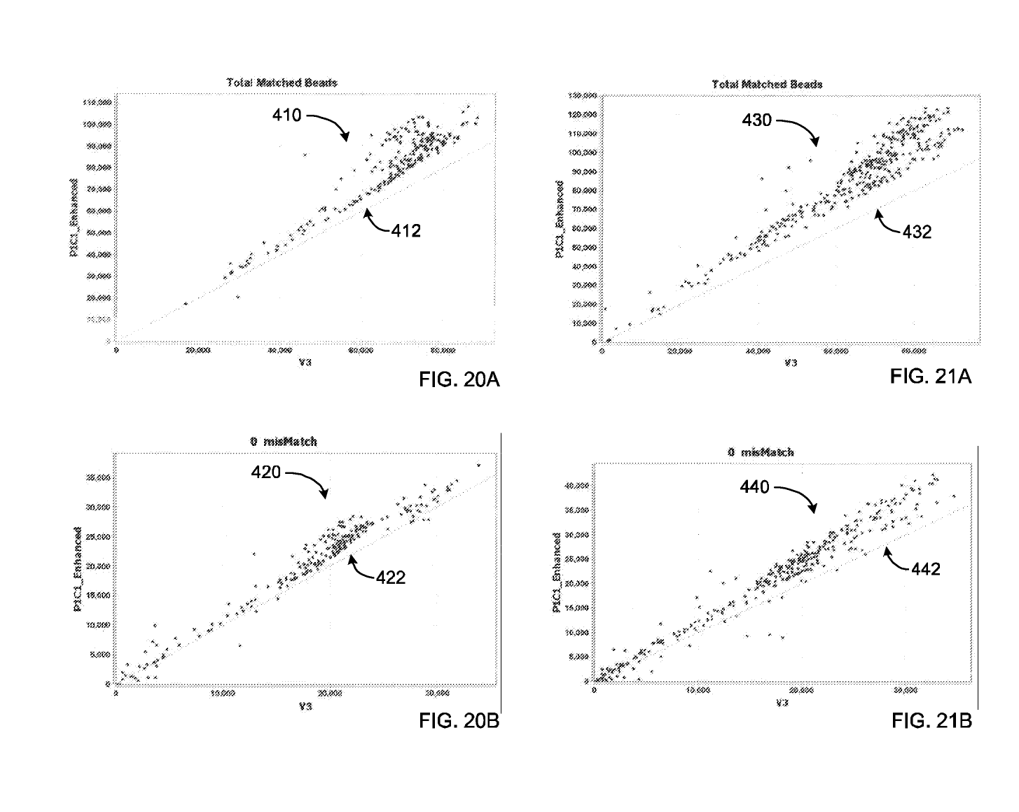

FIGS. 21A and 21B show similar scatter plots 430 and 440 as those of FIGS. 20A and 20B, where bead densities range from about 160K to 220K per panel. As shown, data points for both plots (430, 440) generally lie above their respective reference lines (432, 442).

Table 2 summarizes overall statistics for data corresponding to bead densities in the 120K-to-140K per panel range:

TABLE 2

| | | | (P1C1E − V3)/ |
|---|---|---|---|
| | V3 | P1C1E | V3 (%) |
| Total Identified Beads | 31,936,436 | 40,479,029 | 26.74 |
| Total Matched Beads | 16,426,427 | 19,574,913 | 19.17 |
| Total Perfect Beads | 4,432,180 | 5,060,767 | 14.18 |

In Table 2, V3 column represents bead finding and matching achieved via use of monochromatic focalmap image alone, and P1C1E (P1C1_Enhanced) column represents the same via use of four color P1 images.

As shown in Table 2, bead finding performance improves by approximately 27%, matching performance by approximately 19%, and perfect bead matching performance by approximately 14%. Thus, one can see significant improvements in performance via use of four color P1 images at a bead density region near the upper limit associated with use of monochrome focalmap image alone.

A more dramatic performance improvement can be achieved for bead densities that are above the upper limit associated with use of monochrome focalmap image alone. Table 3 summarizes overall statistics for data corresponding to bead densities in the 160K-to-220K per panel range:

TABLE 3

| | | | (P1C1E − V3)/ |
|---|---|---|---|
| | V3 | P1C1E | V3 (%) |
| Total Identified Beads | 48,526,915 | 70,605,310 | 45.49 |
| Total Matched Beads | 22,428,981 | 29,807,479 | 32.89 |
| Total Perfect Beads | 5,715,870 | 7,069,272 | 23.67 |

As shown in Table 3, bead finding performance improves by approximately 45%, matching performance by approximately 33%, and perfect bead matching performance by approximately 24%. Thus, one can see even more dramatic improvements in performance via use of four color P1 images at bead densities beyond the upper limit associated with use of monochrome focalmap image alone.

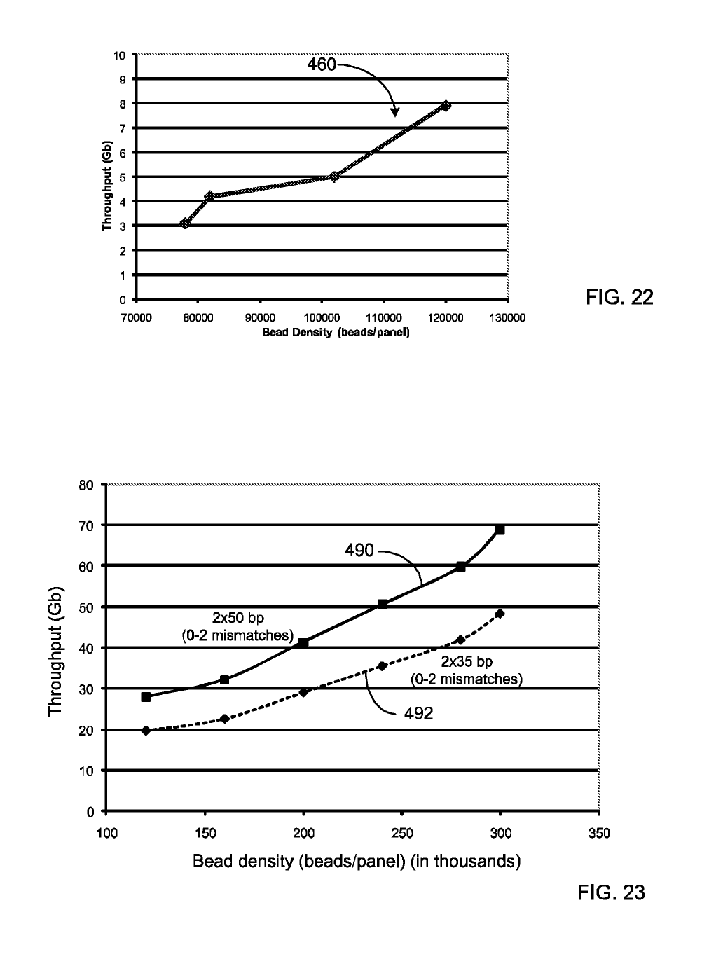

In certain embodiments, an increase in identifiable bead density generally yields an increase in throughput in sequencing processes. For example, FIG. 22 shows a plot 460 of throughput (in Gb) as a function of bead density (beads/panel). The example data 460 is representative of a 2×35 mer mate pair sequencing run at bead densities ranging from about 78,000 beads/panel (about 14×10⁶ beads/cm²) to about 120,000 beads/panel (about 21×10⁶ beads/cm²).

As shown, the increase in throughput is generally proportional to the increase in bead density, with the maximum throughput being about 8 Gb. For the example data shown in FIG. 22, the rate of throughput increase due to bead density increase appears to be about 1.25 Gb per 10K increase in density.

The example data 460 shown in FIG. 22 is representative of throughput capability when bead finding and matching are based on a monochromatic focalmap image. As described herein in reference to FIGS. 19-21, both bead finding and bead matching performance can be improved dramatically by utilizing the four color P1 images. Thus, with use of such plurality of images for mapping of beads in a panel, it is expected that throughput will increase—not only in a density region beyond the monochromatic image-based capability (e.g., above about 130K beads/panel), but also within the monochromatic image-based operating region (e.g., below about 130K beads/panel).

In various embodiments, the above-described approaches comparing bead, particle, and/or feature finding information obtained using subset imaging and comparison to a common image may be altered and/or rearranged as desired. For example, bead finding may be initiated in the common image and augmented using information/bead identifications for the subset images. Likewise, bead finding may be initiated in a selected subset images or images, compared with other subset images, and/or compared to a common image. Alternative analytical approaches utilizing for example the subset images independent of the common image or in connection with the common image irrespective of the order or manner of analysis are understood to be other embodiments of the present teachings.

Based on the foregoing, it is estimated that throughput increases similar to projections of FIG. 23 can be achieved. In FIG. 23, plot 490 shows expected throughput of SOLiD sequencing of 2×50 mer mate pair library. The projected performance assumes that matched beads will have 0-2 mismatches. Plot 492 shows a similar projection for 2×35 mer mate pair sequencing. Both projections are based on metrics from current sequencing runs using current SOLiD v3.0 chemistry. Based on the projection, it is estimated that a SOLiD 2×50 mer mate pair sequencing run with about 280,000 beads/panel (about 50×10⁶ beads/cm²) can potentially achieve a 60 Gb throughput. As described herein, one or more features of the present disclosure can facilitate effective identification of beads in density range shown in FIG. 23.

Although the above-disclosed embodiments have shown, described, and pointed out the fundamental novel features of the invention as applied to the above-disclosed embodiments, it should be understood that various omissions, substitutions, and changes in the form of the detail of the devices, systems, and/or methods shown may be made by those skilled in the art without departing from the scope of the invention. Consequently, the scope of the invention should not be limited to the foregoing description, but should be defined by the appended claims.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

What is claimed is:

1. A method for microparticle identification used in sequencing processes, comprising:
for one or more of a plurality of subsets of microparticles contained within a set of microparticles distributed within an area, obtaining a subset image representative of the microparticles and based on signals resulting from detectable characteristic associated with the subset of microparticles distributed within the area;
identifying the microparticles in each subset image; and
combining the microparticle identifications obtained from the subset images so as to yield a combined set of microparticle identifications.

2. The method of claim 1, wherein the detectable characteristic comprises detecting a distinguishable fluorescence characteristic associated with each of the subset of microparticles.

3. The method of claim 2, wherein the distinguishable fluorescence characteristic is associated with a probe which selectively hybridizes to a target associated with the subset of microparticles.

4. The method of claim 3, wherein the probe comprises a labeled nucleic acid molecule that selectively interacts with a target nucleic acid molecule associated with the subset of microparticles.

5. The method of claim 2, wherein the distinguishable fluorescence characteristic is one of N distinguishable wavelengths, the quantity N being greater than one.

6. The method of claim 1, further comprising comparing the combined microparticle identifications to a common image of the set of microparticles so as to yield an enhanced list of microparticles identifications which includes the combined microparticle identifications augmented with microparticles identified in the common image.

7. The method of claim 6, wherein the common image comprises an image obtained using a probe that hybridizes to a target associated with each of the set of microparticles, the probe comprising a label having a common fluorescence characteristic.

8. The method of claim 7, wherein the common fluorescence characteristic comprises a detectable wavelength such that the common image comprises a substantially monochromatic image.

9. The method of claim 6, wherein the comparing operation comprises determining whether one or more microparticles of the combined microparticle identifications is present in the common image and generating a list of microparticles representative of combined microparticle identifications together with microparticle identifications found in the common image but not the combined microparticle identifications.

10. The method of claim 9, wherein the determining operation comprises assigning one or more pixels associated with each of the microparticles in the common image such that a microparticle is considered to be present in the common image if the position of the microparticle occupies one or more assigned pixels.

11. The method of claim 10, wherein the one or more pixels comprise a S×S array of pixels, the center of the S×S array corresponding to the approximate center position of the microparticle.

12. The method of claim 11, wherein the S×S array has an odd number of pixels on each side such that the center of S×S array is a center pixel corresponding to the center position of the microparticle.

13. A method for imaging in a biological analysis process, comprising:
providing a set of particles to an area, the set of particles distributed over the area and configured to facilitate a plurality of reactions between analytes associated with the particles and reagents introduced to the particles, the set of particles comprising N subsets of particles, the quantity N being greater than one, each subset having particles distributed over the area and capable of emitting signals detectably different than signals from another subset of particles during at least some of the plurality of reactions;
generating an enhanced list of identified particles of the set by:
obtaining N images of the area, each image corresponding to signals from each of the N subsets of particles;
for each of the N images, identifying at least some of the subset of particles; and
combining the identified particles of the subsets; and
for a given reaction, obtaining N images corresponding to the detectably different signals from the area and identifying particles in the N images based on the enhanced list of identified particles.

14. The method of claim 13, wherein the set of particles comprises a set of sequencing beads.

15. The method of claim 14, wherein the analytes comprise strands of nucleic acid templates being sequenced and the reagents comprise probes having fluorescent markers such that the detectably different signal comprises a detectably different fluorescent signal.

16. The method of claim 15, wherein each of the strands of nucleic acid templates are attached to a corresponding bead via one of N primers such that substantially all of beads in a given subset have substantially the same primer, each primer being configured to allow hybridization of a unique labeled probe that emits the detectably different fluorescent signal for generating the bead-subset image.

17. The method of claim 16, wherein the hybridization of the unique labeled probe and primer for generating the bead-subset image results in a fluorescent signal at a location that is proximate to the bead.

18. The method of claim 17, wherein the imaging of the bead-subset images occurs during a first of one or more ligation cycles involving the primer.

19. The method of claim 13, wherein the generating of the enhanced list further comprises:
obtaining a common list of identified particles from a common image associated with the set of particles; and
for each of the identified particles of the subsets, adding the particle to the common list if the particle is not present in the common list.

20. The method of claim 19, wherein the identified particles of the subsets are ranked based on a quality value such that higher-quality particles have greater likelihood of being added to the common list.

21. The method of claim 20, wherein the quality value comprises an intensity of the signal.

22. The method of claim 21, wherein the signal comprises a fluorescent light signal.

23. A biological analysis system, comprising:
a flow cell configured to receive a population of microparticles distributed in an area and facilitate a sequence of reactions between analytes coupled to the microparticles and reagents flowing selectively through the flow cell, each of the microparticles being in one of N sub-populations based on type of signal emitted during a selected portion of the sequence of reactions, each sub-population of microparticles distributed in the area;
an assembly of optical elements configured to form an image of the area;
an imaging detector configured to detect the image and generate a signal representative of the image; and
a processor configured to induce imaging of each of the N sub-populations of microparticles based on the type of signal, the processor further configured to process the N images to identify microparticles therein and combine the identified microparticles from the N images to yield an enhanced list of identified microparticles.

24. The system of claim 23, wherein the area comprises one of one or more panels defined on a surface of the flow cell.

25. The system of claim 23, wherein the analytes comprise strands of nucleic acid templates being sequenced.

26. The system of claim 25, wherein the sequence of reactions comprises a plurality of ligation cycles to interrogate the sequence of the nucleic acid template strands.

27. The system of claim 26, wherein the nucleic acid templates are coupled to the microparticles via unique primers, each of the unique primers being one of N types such that microparticles in each sub-population have substantially same unique primers.

28. The system of claim 27, wherein the nucleic acid templates are coupled to the primers via a common sequence.

29. The system of claim 26, wherein the processor is further configured to induce imaging of the population of microparticles based on a signal common to the population of microparticles so as to yield a common image.

30. The system of claim 29, wherein the common image is used as a basis for generation of the enhanced list.

31. The system of claim 29, wherein the common signal is obtained from hybridization of a common labeled probe to a primer attached to distal end of each of the nucleic acid template strands.

32. A storage medium having a computer-readable instruction, the instruction comprising:
obtaining data representative of N images, each of the N images corresponding to detection of microparticles having a distinguishable fluorescence characteristic; and
for each of the N images:
identifying microparticles in the image;
aligning the image to a common image such that the N images share a substantially common frame of reference; and
ranking the identified microparticles based on fluorescent intensity so as to provide preference to identified microparticles having higher intensity values.

33. The storage medium of claim 32, wherein the common image comprises a monochromatic image resulting from a common fluorescence characteristic among substantially all of the microparticles corresponding to the N images.

34. The storage medium of claim 32, further comprising combining the ranked microparticles from the N images so as to generate a list of identified microparticles.

35. The storage medium of claim 34, further comprising sorting the list of identified m based on fluorescent intensity.
